(19) United States
(12) Patent Application Publication
(10) Pub. No.: US 2024/0287342 A1
(43) Pub. Date: Aug. 29, 2024

(54) RADIATION INDUCED PRINTING METHOD USING AN EFFECT PIGMENT MIXTURE

(71) Applicant: Heliosonic GmbH, Wesel (DE)

(72) Inventors: Volker Jordan, Wesel (DE); Udo Lehmann, Wesel (DE)

(21) Appl. No.: 18/572,821

(22) PCT Filed: Jul. 1, 2022
(86) PCT No.: PCT/EP2022/068268

§ 371 Date: Dec. 21, 2023

(30) Foreign Application Priority Data
Jul. 2, 2021 (EP) 21183503.8

(51) Int. Cl. C09D 11/50; B41M 5/385; C09D 11/037; C09D 11/101; C09D 11/106

(52) U.S. Cl. CPC C09D 11/50; B41M 5/385; C09D 11/037; C09D 11/101; C09D 11/106

(57) ABSTRACT

This invention is directed to a method of a radiation induced printing comprising the following steps: printing a printing ink comprising effect pigments on an ink carrier, which is optically transparent at a certain wavelength; followed by irradiating the ink carrier by means of an energy-emitting apparatus emitting energy in the form of electromagnetic waves, wherein the printing ink absorbs energy of the electromagnetic waves and undergoes a change in volume and/or position causing a transfer of droplets of the printing ink from the ink carrier to an imprinting material, wherein the printing ink comprises an effect pigment mixture containing flaky pearlescent pigments and flaky metal effect pigments.

The present invention relates to a method of printing effect pigments and particularly pearlescent pigments by the laser-induced forward transfer (LIFT) process. It also relates to the use of an effect pigment mixture in radiation induced printing methods.

The laser-induced forward transfer (LIFT) process is a direct-write process which has particular advantages when compared to traditional printing processes such as silk-screen printing processes or gravure printing processes. Contrary to the latter, the laser-induced forward transfer process, similar to an inkjet printing process, allows versatile use without expensive equipment and, in particular, personalized adaptations of the printing motive are easily available. In addition, improvements in printing speed, scale and resolution of the printing process and product are highly welcome.

So far, LIFT processes have been used in particular for the production of electronic, optical and sensor elements, especially for microelectronic components such as antennas, sensors and embedded circuits, but also for transferring biological materials from one substrate to another.

The LIFT process may be performed in several variants.

In a first variant, a printing ink layer containing laser absorbing particles is applied onto a surface of a laser transparent substrate. The transparent substrate (the ink carrier) is then irradiated by a laser beam from the reverse side which does not carry the printing ink. The incident laser beam propagates through the transparent carrier before the light is absorbed by the back surface of the printing ink layer. Above a specific threshold of the incoming laser energy, the printing ink is ejected in form of a droplet from the coated surface of the laser transparent substrate and catapulted towards an imprinting material that is arranged in close proximity to the inked ink carrier surface. The energy conversion process causing the ink ejection as well as the phase transitions involved in the LIFT process is complex and affected by a large number of diverse parameters. Since the absorber particles are contained in the printing ink, these absorber particles absorb laser energy as well and are transferred to the imprinting material too in a certain amount. By this process, a printed ink spot is available at the receiving substrate, containing at least the solidified components of the printing ink droplet containing a certain amount of the absorber particles. Usually, nano-sized carbon black particles have been used in the first variant as absorber particles. A technically useful process and apparatus to perform the LIFT process according to the first variant is disclosed in EP 1 485 255 B1.

WO 2019/175056 A1 discloses metal effect pigments which can be printed by the LIFT process.

WO 2019/154826 discloses metal oxide particles such as antimony tin oxide (ITO) containing pigments as absorber particles in a LIFT process. This document does not disclose the printing of effect pigments such as pearlescent pigments.

WO 2019/154980 A1 discloses pearlescent pigments which can be printed by the LIFT process. In this document no metallic particles are used at all as absorber particles. Here, rather high laser energies are needed to enable the transfer process. Therefore, pulsed laser systems are preferred in this document. With pulsed lasers, however, the printing speed is rather low and therefore no printing processes with high efficiency can be realized.

Typically pearlescent pigments exhibit effects like an optical depth due to their transparency (pearl effect), angle dependent color and lightness and high gloss. Especially in case of multilayer pearlescent pigments also changes of the hue at different angles of incidence and/or observation can be achieved.

There is a need to provide a LIFT printing process which enables a printing of pearlescent effects with high speed but using lower energy for the radiation source.

The object of the invention is solved by providing a method of a radiation induced printing process comprising the following steps:
A) printing a printing ink (2) comprising effect pigments on an ink carrier (1), which is optically transparent at a certain wavelength; followed by
B) irradiating the ink carrier by means of an energy-emitting apparatus emitting energy in the form of electromagnetic waves (3) comprising the certain wavelength during a process period, wherein the printing ink (2) absorbs energy of the electromagnetic waves and undergoes a change in volume and/or position causing a transfer of droplets of the printing ink from the ink carrier to an imprinting material (6),
characterized in that the printing ink comprises a pigment mixture containing
a) flaky pearlescent pigments (4) and
b) flaky metal effect pigments (5).

Further preferred embodiments of this method are depicted in claims 2 to 12 or in aspects 2 to 25.

The object of the invention is further solved by providing the use of a mixture of effect pigments in a printing ink comprising
a) flaky pearlescent pigments and b) flaky metal effect pigments and/or ITO-containing pigments in a radiation induced method of printing.

Further preferred embodiments of this use are depicted in claims 14 to 15 or in aspects 27 to 50

### DESCRIPTION

In this invention the method of a radiation induced printing process comprises the following steps:
A) printing a printing ink (2) comprising effect pigments on an ink carrier (1), which is optically transparent at a certain wavelength; followed by
B) irradiating the ink carrier by means of an energy-emitting apparatus emitting energy in the form of electromagnetic waves (3) comprising the certain wavelength during a process period, wherein the printing ink (2) absorbs energy of the electromagnetic waves and undergoes a change in volume and/or position causing a transfer of droplets of the printing ink from the ink carrier to an imprinting material (6),
characterized in that the printing ink comprises an effect pigment mixture containing
a) flaky pearlescent pigments (4) and
b) flaky metal effect pigments (5).

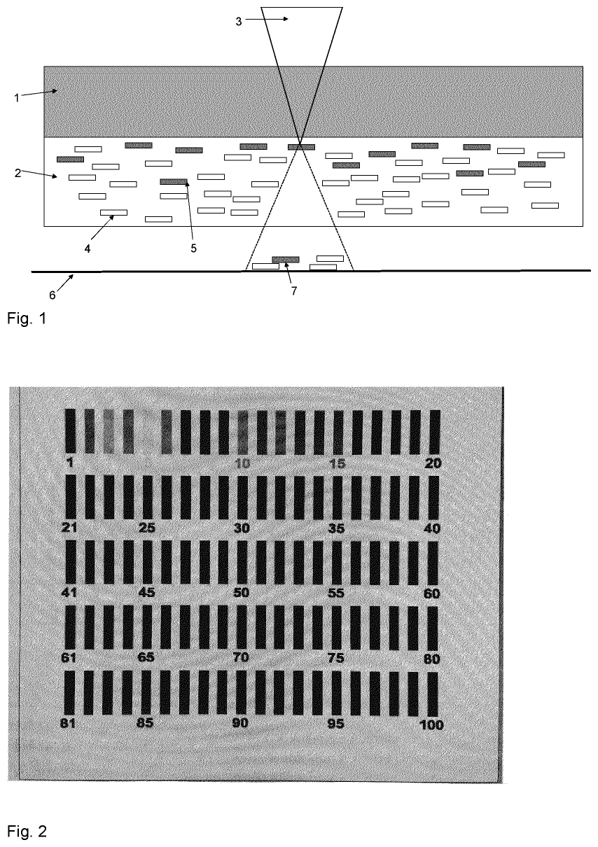

In FIG. 1 the method of printing of the LIFT process is exemplified. The principal method of printing is described in detail in e.g. EP 1485255 B1. The electromagnetic radiation (3), preferably laser radiation hits the ink carrier (1) from the back side. Preferably the angle of incidence is perpendicular, but in certain embodiments also an oblique angle may be chosen. The ink carrier is optically transparent at a certain wavelength and most advantageously the wavelength of the laser is chosen to be in this transparent region in order not to waste laser energy. The printing ink is printed on the ink carrier by conventional printing processes like silk printing or offset printing. The ink carrier may be in form of a plate, a sheet or a flexible film or a ribbon and may be arranged on or around a printing plate or printing cylinder or be part of any other printing assembly known in the art. The ink carrier is preferably made from a polyester material.

The printing ink is printed on the ink carrier by conventional printing processes like silk printing or offset printing. In a preferred embodiment the printing ink is deposited in a reservoir and the ink carrier is constructed as an endless band. All of the coated printing ink thereon which is not transferred to the imprinting material can be thus recycled.

The selected thickness of the printing ink on the ink carrier should be less than 50 μm, preferably less than 30 μm, particularly preferably less than 25 μm. The thickness of the printing ink layer should not fall below 5 μm, however. The optimal range is between 15 and 25 μm.

The imprinting material (6) may be composed of several materials and may be in form of a plate, a sheet, a flexible film or a compact shaped body, as the case may be. Contrary to the ink carrier, the imprinting material (6) may be composed of paper, wallpaper, metal, glass, wood, stone, ceramic materials, polymer materials, etc. The imprinting material is not necessarily transparent. To the contrary, it is of advantage if the imprinting material is semi-transparent or even opaque and may be colored as well. The diminished transparency of the imprinting material as well as a color, if present, can enlarge the visibility of the coloring effects of the pearlescent flaky effect pigments contained in the printed spots on the imprinting material if the concentration of the flaky metal pigments is low enough to not cover the imprinting material.

As schematically shown in FIG. 1 the focused light of the irradiating electromagnetic radiation (3), preferably laser radiation, can be absorbed by especially the flaky metal pigments. These pigments have a great capability to heat up their surrounding which is due to their optical and high heat conduction properties and their flaky shape which ensures a high surface to volume ratio. The surrounding ink can be evaporated and transferred to the imprinting material. Within this transfer all pigments regardless of metal pigments or of pearlescent pigments can be transferred forming dots (7) on the imprinting material. In course of the laser moving further to another position finally a line is printed on the imprinting material.

In preferred embodiments the energy-emitting apparatus emits energy in the form of laser light. This laser can be a CW laser or a pulsed laser. With the help of highly coherent monochromatic laser light, a relatively high amount of energy can be emitted onto a very small area with very short light pulses. As a result, the quality of the print format and in particular the resolution is increased.

In certain embodiments the laser is a pulsed laser. In this case it is preferred that the pulse energy of the electromagnetic waves is in a range of 0.10 to 0.9 mJ and more preferred in a range of 0.12 to 0.85 mJ and most preferred in a range of 0.13 to 0.82 mJ.

For pulsed lasers it is of advantage to use laser with the wavelength of 1064 nm like a Nd:YAG (neodymium doped yttrium aluminum garnet) laser or a Nd:YVO₄ (neodymium doped yttrium vanadate) laser (wavelength 1064.3 nm).

A short light pulse need does not necessarily come from a pulsed laser. It is even more preferable if a laser is used in CW operation instead. Here the pulse duration or better the exposure time does not then depend on the length of the laser pulse but on the scanning speed of the focus. Moreover, the data to be transferred need no longer be synchronized to the fixed pulse frequency. Far higher printing speeds can be achieved with a CW laser. The printing speed of the laser focus is here in the order about 200 to 2,000 m/s. With such speeds a printing line can be printed and a printing process can be established as described in EP 1485255 B1. With these lasers a commercially successful printing process can be established with a wide variety of printing patterns and motives. Here the energy of the laser can be very low in the range of 1 to 50 μJ and more preferably in a range of 10 to 25 μJ.

The laser used is preferably a phase-coupled or a CW laser with an average output of more than 10 watts and a beam parameter M²<1.5 and more preferably M²<1.1. The “switching-on” and “switching-off” of the laser expediently takes place via a pulse-width modulator in combination with a suitable laser switch (e.g. AOM, EOM). However, in the preferred variant of the invention the laser beam is not fully “turned off” but is only reduced in its energy or energy density to below a threshold limit beneath which there is no detachment of drops from the ink carrier. For example there is a reduction in the laser output to about 15% of the value used for a full printing point. This simplifies the control and monitoring of the laser energy when printing, in particular an improved and more effective use of the laser switches or modulators is thereby made possible. In the case where an AOM “switch” is used the laser can thus be used at order 0, while conventional applications of AOM switches have to use the 1^{st} diffraction order. Advantageously the laser has a wavelength between 0.5 μm and 3 μm.

Preferably fiber lasers are used as CW laser due to their high beam quality. These lasers preferably have wavelengths in the range of 1075-1085 nm as here properties like focusing and laser power are best achieved. They may be provided by companies like Trumpf SPI or IPG Laser.

The laser is focused onto the printing ink and depending on the parameters like laser power, wavelength, focal diameter and exposure time of the interaction of the light with the printing ink part of the printing ink is transferred to the imprinting material. The ink carrier coated with the printing ink and the imprinting material are typically separated by a certain distance in the order of about 0.1 to 5.0 mm.

According to this invention the printing ink (2) contains an effect pigment mixture which contains flaky pearlescent pigments (4) and flaky metal pigments (5).

The flaky metal effect pigments primary have a function as absorption particles of the irradiated electromagnetic waves and therefore enable a pigment transfer at lower power. In the following section these effect pigments are further exemplified.

### Flaky Pearlescent Pigments

As flaky pearlescent in principle all pearlescent pigments can be used.

The length and width dimension of all said carrier particles for the pigments according to the invention is in the range from 2 to 350 μm, preferred 4 to 250 μm, more preferred 5 to 100 μm and most preferred 10 to 40 μm as disclosed for the flaky effect pigments already. It also represents the value which is usually referred to as particle size of the carrier particles. The thickness of the carrier particles is generally between 0.05 and 5 μm, preferably from 0.1 to 4.5 μm and particularly preferably from 0.2 to 1 μm. Preferably the lower ends of these forementioned ranges denote to the dio-values and the higher ends to the doo-values of the pearlescent pigments particles size distribution (volume weighted frequency distribution according to Fraunhofer approximation). A dio-value denotes to the size where 10% of the particles of the frequency cumulative size distribution are equal or below this size value. Likewise a doo-value denotes to the size where 90% of the particles of the frequency cumulative size distribution are equal or below this size value. The carrier particles have an aspect ratio (ratio of length to thickness) of at least 2, preferably of at least 10 and particularly preferably of at least 50.

Thickness and aspect ratio mentioned for the carrier particles are also valid for the flaky non-metallic effect pigments according to the present invention, since the coating layer(s) on the carrier particles measure merely some hundreds of nanometers and do, thus, not alter the respective values to a big extent.

The flaky, transparent, dielectric carrier particle is advantageously selected from the group consisting of natural mica platelets, synthetic mica platelets, talc platelets, kaolin platelets, SiO₂-platelets, Al₂O₃-platelets, glass platelets, borosilicate platelets and mixtures of at least two of them. Preferably, natural mica platelets, synthetic mica platelets, SiO₂-platelets, Al₂O₃-platelets and glass platelets are useful, in particular synthetic mica platelets glass platelets. The flaky, transparent, dielectric carrier particles are coated with at least one layer being composed of a metal oxide, a mixed metal oxide or a metal oxide mixture. According to the present invention, all of these layers are named metal oxide layer. Two or more metal oxide layers may also be present on the transparent, dielectric carrier particles. Preferably, these metal oxide layers surround the carrier particles, leading to a continuous metal oxide outer surface layer of the flaky effect pigments.

In certain embodiments the flaky pearlescent pigment comprises a transparent substrate and at least one first high refractive index metal oxide with a refractive index of >1.8, which is laser transparent. More preferably the refractive index of the first metal oxide is ≥2.0.

With “laser transparent” it is meant that essentially no absorption occurs by the metal oxide for the wavelength of the irradiating laser or other light source. The absorption coefficient k of the complex refractive index=n−ik for a laser transparent metal oxide is less than 0.005 and preferably less than 0.003.

Here the absorption coefficient denotes to literature values for the bulk materials and not to the effective absorption coefficient of the respective coating layer of the metal oxide on the pearlescent pigment.

Such laser transparent first metal oxides are preferably TiO₂, ZrO₂, SnO₂, ZnO and mixtures thereof and most preferred are TiO₂ and SnO₂.

These metal oxides are also the typical metal oxides used for pearlescent pigments, if transparent high-refractive index metal oxides are needed for the optical wavelengths. The term “transparent” for high-refractive metal oxides therefore is used herein as common in the art to denote to optical wavelengths, if not indicated otherwise.

Also the term “refractive index” is used herein for the optical wavelengths region and denotes to literature bulk values of the materials.

In preferred embodiments all high refractive index metal oxides of the pearlescent pigment consist of laser transparent metal oxides. These pearlescent pigments may be also called as “laser transparent pearlescent pigment”.

Especially such laser transparent pearlescent pigments are difficult to be transferred by the LIFT printing method as disclosed in WO 2019/154980 A1 as they do not absorb energy of the incoming laser light and therefore cannot be used well for increasing the temperature in the printing ink. Therefore, such pearlescent pigments are preferred. It has been surprisingly found that these effect pigments can be well transferred and lead to a well-defined pearlescent effect when only very small amounts of flaky metal pigments are used in the effect pigment mixture.

In further embodiments the flaky pearlescent pigment comprises a multilayer structure with at least one layer sequence of high, low and high refractive index materials, wherein the high refractive index materials are laser transparent or transparent and have a refractive index of >1.8 and the low refractive index materials are laser transparent and optically transparent have a refractive index of <1.6.

Such kind of pearlescent pigments are disclosed for example in EP 2346949 B1, WO 2006/088759 A1, EP 0 948 572 B1, JP 07246366, WO 2004067645 A2 or EP 1 025 168 A1.

The low refractive index materials are preferably metal oxides taken from SiO₂, Al₂O₃, MgO and mixtures thereof and from MgF₂.

In further embodiments the flaky pearlescent pigment comprises a transparent substrate and at least one second metal oxide with a refractive index of >1.8, which is laser absorbing.

With “laser absorbing” it is meant that essentially a certain absorption occurs by the metal oxide for the wavelength of the irradiating laser or other light source. The absorption coefficient k for the laser absorbing metal oxide is equal or higher than 0.005 and preferably equal or higher than 0.003.

This laser absorbing high refractive index layers may be present in the pearlescent pigment as a single high refractive index layer with no further high refractive index layers which corresponds to a basic type of pearlescent pigment. In other embodiments this layer may be combined with laser transparent high refractive index layers or with low-refractive index layers.

The at least one laser absorbing second metal oxide is preferably selected from the group consisting of Fe₂O₃, Fe₃O₄, Fe(II) containing iron oxides, Cr₂O₃, SnO, Ti-suboxide, Fe and Ti mixed oxides, CuO, Ce-oxide and mixtures thereof. Additionally TiO₂-layers which are made colored by incorporating pigments or dyes may be possible. Most preferred absorbing metal oxide are Fe₂O₃ and Fe(II) containing iron oxides. Again these metal oxides usually coincide with the well-known high refractive index metal oxides which are absorbing in the optical wavelength region. Therefore, these metal oxides have an absorption color and can at the same time, depending on their thickness, act in interference phenomena of the pearlescent pigment.

In order to act as laser absorbing metal oxide the thickness of such second metal oxide should be at least such high that an optical effect in the pearlescent pigment is achieved. Such pearlescent pigment may be called “laser absorbing pearlescent pigment”.

Typically the thickness of such second laser absorbing metal oxide is at least 20 nm, preferably at least 30 nm and more preferably at least 40 nm.

In further embodiments the flaky pearlescent pigment comprise a so-called multilayer structure with at least one layer sequence of high, low and high refractive index materials, wherein at least one of the high refractive index materials have a refractive index of >1.8 and are laser absorbing or absorbing metal oxides and the low refractive index materials have a refractive index of <1.6. Such kind of pearlescent pigments are disclosed for example in EP 2367889 B1, DE 19525503 A1, DE 19953655 A1, EP 2356181 B1, WO 2004/055119 A1, WO 2002/090448 A2 or EP 0 753 545 B2.

In these multilayer pearlescent pigments the laser absorbing high-refractive index layer may be the first layer located near the substrate or the outermost layer or both of the high-refractive index layers.

In further embodiments the flaky pearlescent pigment comprises a first layer 2 made of a metal oxide with a high refractive index and a second layer 3 made of a metal oxide with a high refractive index, wherein each of layers 2 and 3 comprise at least two metal ions and in between these layer a porous spacer layer is located. Such pearlescent pigments also resemble a multilayer structure with a stack of high-low-high refractive index metal oxide layers, but here no low index metal oxide is deposited of the pigment, but rather the porous spacer layer is composed mainly from holes and has connections which bind to layers 2 and 3. These pearlescent pigments can be achieved when certain sequences of high refractive index metal oxides are deposited. The porous spacer layer forms upon the calcination of the coated pearlescent pigments due to a diffusion process of metal ions. In certain embodiments the high reflective index metal oxide layers are formed from transparent or laser transparent metal oxides. Such effect pigments are further disclosed in EP 3034564 B1.

In other embodiments the high reflective index metal oxide layers are formed from at least one absorbing or laser absorbing metal oxides. Such effect pigments are further disclosed in EP 3034562 B1, EP 3034563 B1 or EP 3234025 B1.

In further embodiments the pearlescent pigments are silvery pearlescent pigments with optical properties reflecting a metallic look. Such effect pigment mixtures can advantageously be used when the final printed ink is needed for radar transparency. These pearlescent pigments usually have optical properties such that the resulting color in reflection is essentially a neutral silver tone or a slightly colored tone and in absorption grey to anthrazite shades. With respect to pearlescent pigments the color tone “anthrazite” is also often referred to as “black”. In this invention the term “silvery pearlescent pigments” is used for pearlescent pigments which have a combination of neutral silver or slightly colored reflection color and grey to anthrazite absorption color providing a metallic-like characteristic.

Preferably these silvery pearlescent pigments taken from the group consisting of:
i) pearlescent pigments comprising a transparent substrate which is coated with a high-refractive index layer with n>1.8, which comprises or consists of an iron-oxide with Fe(II)-ions,
ii) pearlescent pigments comprising a transparent substrate which is coated with a high-refractive index layer with n>1.8, which comprises or consists of titanium suboxide or a pearlescent pigment comprising a substrate with a high-refractive index with n>1.8 layer, which comprises or consists of a titanium suboxide that is optionally coated with a high-refractive index layer with n>1.8,
iii) pearlescent pigments comprising a transparent substrate which is coated with a high-refractive index layer with n>1.8, which comprises or consists of titanium oxynitride and mixtures or combinations of the pearlescent pigments i) to iii). These silvery pearlescent pigments exhibit a high hiding power.

In a first preferred embodiment i) the silvery pearlescent pigments used in the effect pigment mixture are pearlescent pigments comprising a transparent substrate which is coated with a high-refractive index layer with n>1.8, which comprises or consists of an iron-oxide with Fe(II)-ions.

In a second preferred embodiment the silvery pearlescent pigment i) has a coating comprising a metal oxide layer comprising Ti and Fe, wherein the iron is mainly Fe(II) ions, which is preferably an ilmenite (FeTiO₃) layer or a magnetite (Fe₃O₄) layer or mixtures thereof.

In a further preferred embodiment the pearlescent pigment has a coating comprising a first layer of TiO₂ followed by a metal oxide layer containing Fe(II)-ions, preferably consisting of ilmenite. Pearlescent pigments with a coating comprising a homogeneously distributed ilmenite (FeTiO₃) have been described in EP 1620511 A2. Pearlescent pigments with a coating comprising first a TiO₂ layer followed by an inhomogeneous distributed ilmenite layer have been described in WO 2012/130776 A1.

Further examples of such pearlescent pigments are disclosed in EP 246523 A2, EP 3119840 A1 (with an Al₂O₃ substrate) or EP 681009 A2 (with a further high-refractive index coating). Pearlescent pigments with a single layer of ilmenite on a TiO₂ platelet substrate have been described in WO 1997/043348 A1. The thicknesses of the layers disclosed in these documents need to be reduced in order to achieve the silvery to grey shaded pearlescent pigments in reflection as demanded in the effect pigment mixture.

In further preferred embodiments the silvery pearlescent pigment comprises the following structure:
(α) a transparent platelet-shaped synthetic substrate,
(β) a titanium oxide layer, followed by
(γ) a metal oxide layer comprising Ti-and Fe-ions, wherein the Fe-ions are mainly Fe(II)-ions.

In a further preferred embodiment the silvery pearlescent pigment has a layer of ilmenite (FeTiO₃).

In further preferred embodiments the pearlescent pigment has an iron(III) oxide content of less than 0.5% by weight, based on the total weight of the pigment. All other amounts of Fe-ions in iron oxides are in the reduced Fe(II) oxidation state.

A higher amount of remaining Fe(III)-ions would lead to an undesired brownish absorption color.

The amounts of Fe(II) or Fe(III) can be determined with Mößbauer spectroscopy or with XPS analysis, possibly combined with sputter profiles.

In further embodiments the total amount of iron compounds, calculated as elemental iron, in the silvery pearlescent pigment according to the invention is less than 5.0% by weight, preferably in a range from 1% by weight to 4.3% by weight, and particularly preferably in a range from 1.4% by weight to 2.9% by weight.

With such low amounts of Fe a silvery color can be well developed. Higher amounts than 5 wt. % lead to pearlescent pigments with a too strong absorption color.

In further preferred embodiments the pearlescent pigment of type a) has an iron/titanium weight ratio as a function of the coating, in accordance with formula (III):

$$\frac{Iron content ( wt . \% )}{Titanium content ( wt . \% )} \times Fraction of the coating ( wt . \% ) \qquad ( I )$$

is in a range from 1 to 8. Herein “iron content” stands for the amount of iron compounds, calculated as elemental iron, and “titanium content” stands for the amount of titanium compounds, calculated as elemental titanium, in each case in the pearlescent pigment and based on the total weight of the pearlescent pigment, and where the “fraction of the coating (% by weight)” stands for the weight fraction, based on the total weight of the pearlescent pigment, of the overall coating applied to the substrate. Preferably this parameter is in a range from 2 to 7.5, particularly preferably in a range from 2.5 to 7, and very particularly preferably in a range from 3 to 6.

This parameter especially ensures that the pearlescent pigment has a silvery color as demanded in this special effect pigment mixture.

In another embodiment ii) the silvery pearlescent pigments comprise a transparent substrate which is coated with a high-refractive index layer with n>1.8 which comprises or consists of a titanium suboxide or a substrate with a high-refractive index n>1.8 layer comprising or consisting of a titanium suboxide that is optionally coated with a high-refractive index layer with n>1.8.

The high-refractive coating layer with n>1.8 of the second kind of pigment is made from a different material than the substrate's titanium suboxide and is preferably TiO₂.

The coated titanium suboxide layer or the titanium suboxide substrate denote to titanium oxides wherein the formal oxidation number of titanium is below 4. They can be represented by the formula:

$${Ti}_{n} {O}_{2 n - 1} \qquad ( II )$$

wherein n in an integer of 1 to 100, preferably n=1 to 10. Typical examples of such compounds are TiO, Ti₂O₃, Ti₃O₅, Ti₄O₇. Mixtures of any such species may be also included.

In further embodiments the titanium suboxide content can be less than 5% based on the total pigment and the main component of said titanium suboxide is Ti₂O₃.

An example of a commercially available pearlescent pigment with titanium suboxide is Iriodin® 9605 (Merck).

In another embodiment iii) the silvery pearlescent pigments comprise a transparent substrate which is coated with a high-refractive index layer with n>1.8, which comprises or consists of titanium oxynitride.

The titanium oxynitrides can be expressed by the general formula:

$${Ti}_{x} {N}_{y} {O}_{z} \qquad ( III )$$

wherein x is 0.2 to 0.6, y is 0.05 to 0.6 and z is 0.1 to 0.9, which comprises a solid solution of nitrogen in titanium monoxide.

Such pearlescent pigments have been described in U.S. Pat. No. 4,623,396 A. Pearlescent pigments with intense blue color or a bluish fade have been described in EP 332071 A1 or in EP 735115 A1. Herein a first TiO₂ layer is reduced with ammonia at temperatures in the range of 750° C. to 850° C. If the optical thickness of the TiO₂ layer deposited in a first step is in the range of 50 to 100 nm silvery effect pigments are obtained.

In EP 842229 B1 pearlescent pigments are described were a platelet-like TiO₂ substrate is first formed by solidification of a hydrolysable aqueous solution of a titanium compound on an endless band. These substrates can be coated with further TiO₂ or other metal oxides and calcined under reducing conditions.

An example of such a commercially available pearlescent pigment is Paliocrom Blausilber L6000 (BASF Colors and Effects GmbH).

In further embodiments mixtures or combinations of the pearlescent pigments a) to c) itself or pearlescent pigments with mixtures or combinations of the various coating layers mentioned in the pearlescent pigments a) to e) can be used.

For example, pearlescent pigments comprising a coating of mixtures or combinations of titanium suboxide and titanium oxynitride may be used.

The concentration of the pearlescent pigments in the printing ink is preferably in a range of 3.0 to 10.0 wt. %, more preferably in a range of 3.5 to 8.0 and more preferably in a range of 4.0 to 7.0 wt. %, each referred to the total weight of the printing ink. Such rather high concentrations are need in order to transfer enough pigment material by the impact of the laser light.

### Flaky Metal Pigments

it is assumed that the flaky metal pigments primary have a function as absorbing pigments for the irradiated electromagnetic waves, especially laser light. They can be preferably made from aluminum, copper, zinc, iron, titanium, zirconium, hafnium, chromium, tin, and alloys thereof such as steel or gold-bronze. More preferred flaky metal pigments are aluminum, copper, iron, and gold-bronze and most preferred are aluminum flaky metal pigments.

In other embodiments the flaky metal pigments may also have a decorative function. The resulting prints therefore are a mixture of pearlescent effects and metal effects.

The flaky metal pigment can be produced by milling process method, by CVD methods or by PVD methods.

The platelet-like aluminum effect pigments can be obtained by grinding of aluminum or aluminum-based alloy shot. The grinding step is typically made in ball mills according to the well-known Hall process using a solvent like white spirit, solvent naphta or isopropanol and as grinding aids fatty acids such as palmitinic acid, stearic acid, oleic acid or mixtures thereof. They can have rather irregular edges like the “cornflake” type or rather rounded edges like the “silberdollar” type.

In preferred embodiment the flaky metal pigments are PVD-pigments and most preferred are aluminum PVD-pigments.

The flaky metal pigment can have any size as known in the art. In preferred embodiments the flaky metal effect pigment has a D₅₀ in a range of 1 to 100 μm, more preferred in a range of 1.5 to 60 μm, further more preferred in a range of 1.8 to 40 μm, most preferred in a range of 1.9 to 25 μm and further most preferred in a range of 2 to 12 μm. Very preferred ranges are also 4 to 40 μm and more preferred 5 to 30 μm.

It is a great advantage that the particle sizes of the flaky metal pigments can be in the ranges of common commercially available metal effect pigments. In contrast to conventional ink jet printing processes as exemplified by EP 1942158 A2 or EP 1862511 A1, there is no need to use very small sized metal effect pigments. In conventional ink jet printing ink processes very small metal effect pigments are needed as otherwise the nozzles and tubes of the ink jet set are plugged. Such small metal effect pigment, however, need to be comminuted in an extra step, usually by using ultras sound impact.

The particle size distribution is measured by laser scattering granulometry using a Helos/BR Multirange (Sympatec) apparatus according to the manufacturer indications and in accordance to ISO 13320-1. The aluminum effect pigments are dissolved in isopropanol under stirring before measuring the particle size distribution. The particle size function is calculated in the Fraunhofer-approximation as a volume weighted cumulative frequency distribution of equivalent spheres. The median value D₅₀ means that 50% of the measured particles are below this value (in a volume-averaged distribution).

The mean thickness as expressed by the median hso of the thickness distribution of the flaky metal pigments can be in a range of 10 nm to 1000 nm, preferably of 15 nm to 400 nm, more preferably in a range of 15 nm to 120 nm, most preferably in a range of 10 to 70 nm and the most preferred range is 15 to 50 nm.

Most preferably the flaky metal pigment is a PVD aluminum effect pigment with a h₅₀ in a range of 15 to 50 nm.

In general, the thickness of the flaky metal pigments can be determined with the aid of a scanning electron microscope (SEM). For this purpose, the particles are incorporated in a concentration of about 10 wt. % into a two-component clearcoat, Autoclear Plus HS from Sikkens GmbH, with a sleeved brush, applied to a film with the aid of a spiral applicator (wet film thickness 26 μm) and dried. After a drying time of 24 h, transverse sections of these applicator drawdowns were produced. The transverse sections were analyzed by SEM (Zeiss supra 35) using the SE (secondary electrons) detector. For a valuable analysis of platelet particles, these should be well oriented plane-parallel to the substrate to minimize the systematic error of the angle of inclination caused by misaligned flakes.

Here, a sufficient number of particles should be measured so as to provide a representative mean value. Customarily, approximately 100 particles are measured. The h₅₀-value is the median value of the particle thickness distribution determined by this method. This h₅₀-value can be used as a measure of the mean thickness.

A detailed procedure of the determination of the thickness distribution and the h₅₀-values of flaky metal pigments is also described in EP 1613702 B1.

In some embodiments the flaky metal pigments are black PVD pigments produced by reactive PVD process in a partial oxygen containing atmosphere. Such effect pigments are disclosed in EP 2262864 B1. These black metallic PVD pigments absorb electromagnetic waves extremely well and therefore are very efficient as absorbing pigments.

### Printing Ink Containing Flaky Pearlescent Pigments and Flake Metal Pigments

The optimal ratio of the two effect pigments depends on the nature of the flaky metallic pigments as well as on the nature of the pearlescent pigment and can be determined by the skilled person without undue effort. Particularly it should be differentiated between using a pulsed laser or a CW laser as radiation source. Also in some cases differences were observed when using pearlescent pigments which have laser transparent high refractive metal oxide or laser absorbing high refractive metal oxide coatings.

The amount of flaky metal pigments needed for the energy absorption is usually low and especially in the case of using a pulsed laser as energy-emitting apparatus the concentration of the flaky metal pigments in the printing ink generally is preferably in a range of 0.01-1.50 wt. % and more preferably in a range of 0.02-1.25 wt. %, each referred to the total printing ink.

If here the pearlescent pigment is a laser transparent pearlescent pigment a further preferred range of the flaky metal pigment concentration in the ink is 0.02 to 0.50 wt. % and a more preferred range is 0.02 to 0.40 wt. %. Especially in the last range printing within a large range of laser energy can be accomplished.

In case that the pearlescent pigment is a laser absorbing pearlescent pigment a further preferred range of the flaky metal pigment concentration in the printing ink is 0.020 to 0.50 wt. % and a more preferred range is 0.020 to 0.40 wt. %. Especially in the last range printing within a large range of laser energy can be accomplished.

When the laser is a pulsed laser the weight ratio of the flaky metal effect pigment to the flaky pearlescent pigment in the effect pigment mixture contained in the printing ink is preferably in a range of 0.002 to 0.30 and more preferably in a range of 0.004 to 0.25. Below of 0.002 the effect of energy absorption is not strong enough and above 0.30 the optical properties of the flaky metal pigment predominate the ones of the pearlescent pigment or even a destroying effect on the final printing can be observed which is most likely due to an overheating effect, because of the large energy impact in case of pulsed lasers to the metal effect pigments.

If the pearlescent pigment is a laser transparent pearlescent pigment it is further preferred that the weight ratio of the flaky metal effect pigment to the flaky pearlescent pigment in the effect pigment mixture contained in the printing ink is in a range of 0.008 to 0.20 and most preferred in an range of 0.020 to 0.060.

Is the pearlescent pigment has at least one laser absorbing metal oxide coating it is further preferred that the weight ratio of the flaky metal effect pigment to the flaky pearlescent pigment in the effect pigment mixture contained in the printing ink is in a range of 0.004 to 0.10 and most preferred in an range of 0.004 to 0.08.

Especially when used in very small concentrations the flaky metal pigments only act as absorber of the irradiated electromagnetic waves ensuring a sufficient temperature increase and therefore a good transfer of the printing ink to the imprinting material. In the final printed picture the flaky metal pigments are not or almost not influencing the visual effect which than determined by the pearlescent pigments.

At higher concentrations attractive optical effects resulting from a mixture of metallic and pearlescent effects may be achieved.

When the pearlescent is coated with a laser transparent high refractive-index metal oxide and a CW laser is used than the concentration of flaky metal pigments in the printing ink is preferably in a range of 0.15 to 10.0 wt. %, more preferably in a range of 0.20-5.0 wt. %, even more preferably in a range of 0.25-1.50 wt. %, further more preferably in a range of 0.30-1.25 wt. % and most preferably in a range of 0.35-1.00 wt. %, each referred to the total printing ink.

In certain embodiments it is possible to achieve a pearlescent effect in the printed film even at high concentrations of flaky metal pigments of up to 10 wt. %. Usually the concentration will be much lower as due to their beneficial absorbing properties the flaky metal pigments can be used in low concentrations. At lower concentrations also the pearlescent effect is best evolved.

When the pearlescent is coated with a laser transparent high refractive-index metal oxide and the laser is a CW laser the weight ratio of the flaky metal effect pigment to the flaky pearlescent pigment in the pigment mixture contained in the printing ink is preferably in a range of 0.03 to 2.00, more preferably in a range of 0.04-1.00, further more preferably in a range of 0.050 to 0.30, even more preferably in a range of 0.06 to 0.25 and most preferably in a range of 0.07 to0.20.

When using a CW laser usually more flaky metal pigments are needed to ensure pigment transfer of the printing ink to the substrate as the local energy impact is lower than in case of pulsed lasers. Especially in case of laser absorbent pearlescent pigments even more flaky metal pigments are needed. Therefore, for this case the concentration of the flaky metal pigments in the printing ink is preferably in a range of 0.45 to 10.0 wt. %, more preferably in a range of 0.50 to 5.0 wt. %, further more preferred in a range of 0.51 to 1.50 wt. %, even more preferred in a range of 0.55 to 1.25 wt. % and most preferably in a range of 0.60 to 1.00 wt. %, each referred to the total printing ink. For this case also the weight ratio of the flaky metal effect pigment to the flaky pearlescent pigment in the pigment mixture contained in the printing ink is preferably in a range of 0.095 to 2.00, more preferably in a range of 0.10 to 1.00, further more preferably in a range of 0.125 to 0.30, even further preferably in an range of 0.15 to 0.25 and most preferably in a range of 0.15 to 0.20.

The printing ink can additionally contain further pigments or dyes or further effect pigments. These further pigments can be organic or inorganic pigments. Usually such pigments are added for coloristic reasons but not in order to create an absorption pigment. It is assumed that the flaky metal pigment mainly acts as absorbing pigment for the irradiated radiation, preferably laser radiation.

In preferred embodiments the concentration of the flaky pearlescent pigments and of the flaky metal pigments is in a range of 80 to 100% and more preferably in a range of 95 to 100% with reference to the total amount of pigments and effect pigments in the printing ink.

Advantageously the printing ink is selected such that the viscosity lies between 0.05 and 0.5 Pas.

In certain embodiments the printing ink contains additionally a solvent and a binder. Dowanol PM, dibasic ester, methoxy butyl glycol, alcohols like ethanol.

Preferred binder of the printing ink include PVB, ethyl cellulose, (meth)acrylates, polyester, polyurethanes (1K or 2K) or PVC.

In other embodiments the printing ink contains monomers or oligomers instead of solvent (UV curable). Further, the printing ink may contain other ingredients common from printing inks like dispersing additives, blowing agents, rheology agents like thickeners, anti-foaming agents, levelling agents, coupling agents, anti-sagging agents, corrosion inhibitors, stabilizers or fire redundants.

All features described herein for the method of radiation induced printing do also apply for the use of the effect pigment mixture in a printing ink for radiation induced printing methods.

### Aspects

According to aspect 1 of this invention it is concerned with a method of a radiation induced printing process comprising the following steps:
A) printing a printing ink (2) comprising effect pigments on an ink carrier (1), which is optically transparent at a certain wavelength; followed by
B) irradiating the ink carrier by means of an energy-emitting apparatus emitting energy in the form of electromagnetic waves (3) comprising the certain wavelength during a process period, wherein the printing ink (2) absorbs energy of the electromagnetic waves and undergoes a change in volume and/or position causing a transfer of droplets of the printing ink from the ink carrier to an imprinting material (6),
characterized in that the printing ink comprises an effect pigment mixture containing
a) flaky pearlescent pigments (4) and
b) flaky metal effect pigments (5).

A further aspect 2 of this invention is concerned with a method of a radiation induced printing process according to aspect 1, wherein the energy-emitting apparatus is a laser.

A further aspect 3 of this invention is concerned with a method of a radiation induced printing process according to aspect 1 or 2,
wherein the energy-emitting apparatus is a pulsed laser and wherein the pulse energy of the electromagnetic waves is in a range of 0.10 to 0.90 mJ.

A further aspect 4 of this invention is concerned with a method of a radiation induced printing process according to aspect 1 or 2,
wherein the energy-emitting apparatus is a CW laser, wherein the energy of the electromagnetic waves is in a range of 1 to 50 mJ.

A further aspect 5 of this invention is concerned with a method of a radiation induced printing process according to any of the preceding aspects, wherein the flaky metal effect pigment has a D₅₀ in a range of 1 to 100 μm.

A further aspect 6 of this invention is concerned with a method of a radiation induced printing process according to any of the preceding aspects, wherein the flaky metal effect pigment has a D₅₀ in a range of 4 to 40 μm.

A further aspect 7 of this invention is concerned with a method of a radiation induced printing process according to any of the preceding aspects,
wherein the flaky metal effect pigment has an average thickness in a range of 15 to 50 nm and is preferably a PVD aluminum effect pigment.

A further aspect 8 of this invention is concerned with a method of a radiation induced printing process according to any of the preceding aspects,
wherein the flaky metal effect pigment is based on a PVD pigment produced by reactive PVD process in a partial oxygen containing atmosphere.

A further aspect 9 of this invention is concerned with a method of a radiation induced printing process according to any of the preceding aspects,
wherein the flaky pearlescent pigment comprises a transparent substrate and at least one first metal oxide with a refractive index of >1.8, wherein this first metal oxide is laser transparent.

A further aspect 10 of this invention is concerned with a method of a radiation induced printing process according to aspect 9,
wherein the at least one laser transparent first metal oxide is selected from the group consisting of TiO₂, ZrO₂, SnO₂, ZnO and mixtures thereof.

A further aspect 11 of this invention is concerned with a method of a radiation induced printing process according to any of the preceding aspects,
wherein the flaky pearlescent pigment comprises a multilayer structure with at least one layer sequence of high, low and high refractive index materials, wherein the high refractive index materials are laser transparent and have a refractive index of >1.8 and the low refractive index materials are transparent and have a refractive index of <1.6.

A further aspect 12 of this invention is concerned with a method of a radiation induced printing process according to any of aspects 9 to 10, wherein the flaky pearlescent pigment comprises a first layer 2 made of a first laser transparent metal oxide with a high refractive index and a second layer 3 made of a first laser transparent metal oxide with a high refractive index, wherein each of layers 2 and 3 comprise at least two metal ions and in between these layers a porous spacer layer is located.

A further aspect 13 of this invention is concerned with a method of a radiation induced printing process according to any of aspects 1 to 12
wherein the flaky pearlescent pigment comprises a transparent substrate and at least one laser absorbing metal oxide with a refractive index of >1.8.

A further aspect 14 of this invention is concerned with a method of a radiation induced printing process according to aspect 13,
wherein the at least one laser absorbing metal oxide is selected from the group consisting of Fe₂O₃, Fe₃O₄, Fe(II) containing iron oxides, Cr₂O₃, SnO, Ti-suboxide, Fe and Ti mixed oxides, CuO, Ce-oxide and mixtures thereof.

A further aspect 15 of this invention is concerned with a method of a radiation induced printing process according to aspects 13 or 14,
wherein the pearlescent pigments are silvery pearlescent pigments taken from the group consisting of:
i) pearlescent pigments comprising a transparent substrate which is coated with a high-refractive index layer with n>1.8, which comprises or consists of an iron-oxide with Fe(II)-ions,
ii) pearlescent pigments comprising a transparent substrate which is coated with a high-refractive index layer with n>1.8, which comprises or consists of titanium suboxide or a pearlescent pigment comprising a substrate with a high-refractive index with n>1.8 layer, which comprises or consists of a titanium suboxide that is optionally coated with a further high-refractive index layer with n>1.8,
iii) pearlescent pigments comprising a transparent substrate which is coated with a high-refractive index layer with n>1.8, which comprises or consists of titanium oxynitride, and mixtures or combinations of the pearlescent pigments a) to c).

A further aspect 16 of this invention is concerned with a method of a radiation induced printing process according to any of aspects 13 to 14,
wherein the flaky pearlescent pigment comprises a multilayer structure with at least one layer sequence of high, low and high refractive index materials, wherein at least one of the high refractive index materials have a refractive index of >1.8 and are laser absorbing and the low refractive index materials have a refractive index of <1.6.

A further aspect 17 of this invention is concerned with a method of a radiation induced printing process according to any of aspects 13 to 14, wherein the flaky pearlescent pigment comprises a first layer 2 made of a metal oxide with a high refractive index and a second layer 3 made of a metal oxide with a high refractive index, wherein each of layers 2 and 3 comprise at least two metal ions and in between these layers a porous spacer layer is located.

A further aspect 18 A further aspect 19 of this invention is concerned with a method of a radiation induced printing process according to any of aspects 9 to 12, wherein the laser is a pulsed laser and the concentration of the flaky metal pigments in the printing ink is in a range of 0.02 to1.50 wt. %, preferably in a range of 0.02 to 1.25 wt. %, more preferably in a range of 0.04 to 1.00 wt. % and most preferably in a range of 0.10 to 0.30 wt. %, each referred to the total printing ink.

A further aspect 19 of this invention is concerned with a method of a radiation induced printing process according to aspects,
wherein the laser is a pulsed laser and the pearlescent pigments have a transparent high refractive index layer according to aspects 9 to 12, wherein the weight ratio of the flaky metal effect pigment to the flaky pearlescent pigment in the effect pigment mixture contained in the printing ink is in a range of 0.002 to 0.30, preferably in a range of 0.004 to 0.25, more preferably in a range of 0.008 to 0.20 and most preferably in an range of 0.020 to 0.060.

A further aspect 20 of this invention is concerned with a method of a radiation induced printing process according to any of aspects 9 to 12, wherein the laser is a CW laser and the concentration of flaky metal pigments in the printing ink is in a range of 0.15 to 10.0 wt. %, preferably in a range of 0.20 to 5.0 wt. %, more preferably in a range of 0.25 to 1.50 wt. %, even more preferably in a range of 0.30 to 1.25 wt. % and most preferably in a range of 0.35 to 1.00 wt. %, each referred to the total printing ink.

A further aspect 21 of this invention is concerned with a method of a radiation induced printing process according to aspects 9 to 12 or to aspect 20,
wherein the laser is a CW laser and the weight ratio of the flaky metal effect pigment to the flaky pearlescent pigment in the pigment mixture contained in the printing ink is in a range of 0.03 to 2.00, preferably in a range of 0.04 to 1.00, more preferably in a range of 0.05 to 0.30, even more preferably in a range of 0.06 to 0.25 and most preferably in a range of 0.07 to 0.20.

A further aspect 22 of this invention is concerned with a method of a radiation induced printing process according to any of aspects 13 to 17, wherein the laser is a pulsed laser and the concentration of flaky metal pigments in the printing ink is in a range of 0.01 to 1.50 wt. %, preferably in a range of 0.02 to 1.25 wt. %, more preferably in a range of 0.020 to 0.50 wt. % and most preferred is a range from 0.020 to 0.40 wt. %, each referred to the total printing ink.

A further aspect 23 of this invention is concerned with a method of a radiation induced printing process according to aspects 13 to 17,
wherein the laser is a pulsed laser and the weight ratio of the flaky metal effect pigment to the flaky pearlescent pigment in the pigment mixture contained in the printing ink is in a range of 0.002 to 0.30, preferably in an range of 0.004 to 0.25, more preferably in a rage of 0.004 to 0.10 and most preferably in a range of 0.004 to 0.08.

A further aspect 24 of this invention is concerned with a method of a radiation induced printing process according to any of aspects 13 to 17, wherein the laser is a CW laser and the concentration of flaky metal pigments in the printing ink is in a range of 0.45 to 10.0 wt. %, more preferably in a range of 0.50 to 5.0 wt. %, further more preferred in a range of 0.51 to 1.50 wt. %, even more preferred in a range of 0.55 to 1.25 wt. % and most preferably in a range of 0.60 to 1.00 wt. %, each referred to the total printing ink.

A further aspect 25 of this invention is concerned with a method of a radiation induced printing process according to aspects 13 to 17 or aspect 24,
wherein the laser is a CW laser and weight ratio of the flaky metal effect pigment to the flaky pearlescent pigment in the pigment mixture contained in the printing ink is in a range of 0.095 to 2.00, preferably in a range of 0.10 to 1.00, more preferably in a range of 0.125 to 0.30, further preferably in a range of 0.15 to 0.25 and most preferably in a range of 0.15 to 0.20.

A further aspect 26 of this invention is concerned with the use of a mixture of effect pigments in a printing ink comprising
a) flaky pearlescent pigments and b) flaky metal effect pigments in a radiation induced method of printing.

A further aspect 27 of this invention is concerned with the use of a mixture of effect pigments according to aspect 26, in a method of a radiation induced printing process comprising the following steps:
A) printing a printing ink (2) comprising absorbing pigments on an ink carrier (1), which is optically transparent at a certain wavelength; followed by
B) irradiating the ink carrier by means of an energy-emitting apparatus emitting energy in the form of electromagnetic waves (3) comprising the certain wavelength during a process period, wherein the printing ink (2) absorbs energy of the electromagnetic waves and undergoes a change in volume and/or position causing a transfer of droplets of the printing ink from the ink carrier to an imprinting material (6).

A further aspect 28 of this invention is concerned with the use of a mixture of effect pigments according to any of aspects 26 to 27,
wherein the energy-emitting apparatus is a laser.

A further aspect 29 of this invention is concerned with the use of a mixture of effect pigments according to aspects 27 or 28,
wherein the energy-emitting apparatus is a pulsed laser and the pulse energy of the electromagnetic waves is in a range of 0.10 to 0.9 mJ.

A further aspect 30 of this invention is concerned with the use of a mixture of effect pigments according to aspects 27 or 28,
wherein the energy-emitting apparatus is a CW laser, wherein the energy of the electromagnetic waves is in a range of 1 to 50 mJ.

A further aspect 31 of this invention is concerned with the use of a mixture of effect pigments according to any of aspects 26 to 30, wherein the flaky metal effect pigment has a D₅₀ in a range of 1 to 100 μm.

A further aspect 32 of this invention is concerned with the use of a mixture of effect pigments according to aspect 31, wherein the flaky metal effect pigment has a D₅₀ in a range of 4 to 40 μm.

A further aspect 33 of this invention is concerned with the use of a mixture of effect pigments according to any of aspects 26 to 32,
wherein the flaky metal effect pigment has an average thickness in a range of 15 nm to 50 nm and is preferably a PVD aluminum effect pigment.

A further aspect 34 of this invention is concerned with the use of a mixture of effect pigments according to any of aspects 26 to 32,
wherein the flaky metal effect pigment is based on a PVD pigment produced by reactive PVD process in a partial oxygen containing atmosphere.

A further aspect 35 of this invention is concerned with the use of a mixture of effect pigments according to any of aspects 26 to 34,
wherein the flaky pearlescent pigment comprises a transparent substrate and at least one laser transparent metal oxide with a refractive index of >1.8.

A further aspect 36 of this invention is concerned with the use of a mixture of effect pigments according to aspect 35,
wherein the at least one laser transparent metal oxide is selected from the group consisting of TiO₂, ZrO₂, SnO₂, ZnO and mixtures thereof.

A further aspect 37 of this invention is concerned with the use of a mixture of effect pigments according to any of aspects 35 to 36,
wherein the flaky pearlescent pigment comprises a multilayer structure with at least one layer sequence of high, low and high refractive index materials, wherein the high refractive index materials are laser transparent and the low refractive index materials are transparent and have a refractive index of <1.6.

A further aspect 38 of this invention is concerned with the use of a mixture of effect pigments according to any of aspects 35 or 36,
wherein the flaky pearlescent pigment comprises a first layer 2 made of a metal oxide with a high refractive index and a second layer 3 made of a metal oxide with a high refractive index, wherein each of layers 2 and 3 comprise at least two metal ions and in between these layers a porous spacer layer is located.

A further aspect 39 of this invention is concerned with the use of a mixture of effect pigments according to any of aspects 27 to 38,
wherein the flaky pearlescent pigment comprises a transparent substrate and at least one laser absorbing metal oxide with a refractive index of >1.8.

A further aspect 40 of this invention is concerned with the use of a mixture of effect pigments according to aspect 39,
wherein the at least one laser absorbing metal oxide is selected from the group consisting of Fe₂O₃, Fe₃O₄, Fe(II) containing iron oxides, Cr₂O₃, SnO, Ti-suboxide, Fe and Ti mixed oxides, CuO, Ce-oxide and mixtures thereof.

A further aspect 41 of this invention is concerned with the use of a mixture of effect pigments according to aspect 39 or 40,
wherein the pearlescent pigments are silvery pearlescent pigments taken from the group consisting of:
i) pearlescent pigments comprising a transparent substrate which is coated with a high-refractive index layer with n>1.8, which comprises or consists of an iron-oxide with Fe(II)-ions,
ii) pearlescent pigments comprising a transparent substrate which is coated with a high-refractive index layer with n>1.8, which comprises or consists of titanium suboxide or a pearlescent pigment comprising a substrate with a high-refractive index with n>1.8 layer, which comprises or consists of a titanium suboxide that is optionally coated with a high-refractive index layer with n>1.8,
iii) pearlescent pigments comprising a transparent substrate which is coated with a high-refractive index layer with n>1.8, which comprises or consists of titanium oxynitride, and mixtures or combinations of the pearlescent pigments i) to iii).

A further aspect 42 of this invention is concerned with the use of a mixture of effect pigments according to any of aspects 39 or 40,
wherein the flaky pearlescent pigment comprises a multilayer structure with at least one layer sequence of high, low and high refractive index materials, wherein at least one of the high refractive index materials having a refractive index >1.8 are absorbing and the low refractive index materials have a refractive index of <1.6.

A further aspect 43 of this invention is concerned with the use of a mixture of effect pigments according to any of aspects 39 or 40,
wherein the flaky pearlescent pigment comprises a first layer 2 made of a metal oxide with a high refractive index and a second layer 3 made of a metal oxide with a high refractive index, wherein each of layers 2 and 3 comprise at least two metal ions and in between these layer a porous spacer layer is located.

A further aspect 44 of this invention is concerned the use of a mixture of effect pigments according to any of aspects 35 to 38,
wherein the laser is a pulsed laser and the concentration of the flaky metal pigments in the printing ink is in a range of 0.01-1.50 wt. %, preferably in a range of 0.02 to 1.25 wt. %, more preferably in a range of 0.04 to 1.00 wt. % and most preferably in a range of 0.10 to 0.30 wt. %, each referred to the total printing ink.

A further aspect 45 of this invention is concerned with the use of a mixture of effect pigments according to aspects 35 to 38,
wherein the laser is a pulsed laser and the weight ratio of the flaky metal effect pigment to the flaky pearlescent pigment in the pigment mixture is in a range of 0.002 to 0.30, preferably in a range of 0.004 to 0.25, more preferably in a range of 0.008 to 0.20 and most preferably in an range of 0.020 to 0.060.

A further aspect 46 of this invention is concerned the use of a mixture of effect pigments according to any of aspects 35 to 38,
wherein the laser is a CW laser and the concentration of flaky metal pigments in the printing ink is in a range of 0.15 to 10.0 wt. %, preferably in a range of 0.20 to 5.0 wt. %, more preferably in a range of 0.25 to 1.50 wt. %, even more preferably in a range of 0.30 to 1.25 wt. % and most preferably in a range of 0.35 to 1.00 wt. %, each referred to the total printing ink.

A further aspect 47 of this invention is concerned with the use of a mixture of effect pigments according to aspects 35 to 38,
wherein the laser is a CW laser and weight ratio of the flaky metal effect pigment to the flaky pearlescent pigment in the pigment mixture contained in the printing ink is in a range of 0.03 to 2.00, preferably in a range of 0.04 to 1.00, more preferably in a range of 0.050 to 0.30, even more preferably in a range of 0.06 to 0.25 and most preferably in a range of 0.07 to 0.20.

A further aspect 48 of this invention is concerned with the use of a mixture of effect pigments according to any of aspects 39 to 43,
wherein the laser is a pulsed laser and the concentration of flaky metal pigments in the printing ink is in a range of 0.01-1.50 wt. %, preferably in a range of 0.02 to 1.25 wt. %, more preferably in a range of 0.020 to 0.50 wt. % and most preferred is a range from 0.020 to 0.40 wt. %, each referred to the total printing ink.

A further aspect 49 of this invention is concerned with the use of a mixture of effect pigments according to any of aspects 39 to 43,
wherein the laser is a pulsed laser and the weight ratio of the flaky metal effect pigment to the flaky pearlescent pigment in the pigment mixture contained in the printing ink is in a range of 0.002 to 0.30, preferably in an range of 0.004 to 0.25, more preferably in a rage of 0.004 to 0.10 and most preferably in a range of 0.004 to 0.08.

A further aspect 50 of this invention is concerned with the use of a mixture of effect pigments according to any of aspects 39 to 43,
wherein the laser is a CW laser and the concentration of flaky metal pigments in the printing ink is in a range of 0.45 to 10.0 wt. %, more preferably in a range of 0.50 to 5.0 wt. %, further more preferred in a range of 0.51 to 1.50 wt. %, even more preferred in a range of 0.55 to 1.25 wt. % and most preferably in a range of 0.60 to 1.00 wt. %, each referred to the total printing ink.

A further aspect 51 of this invention is concerned with the use of a mixture of effect pigments according to aspects 39 to 43,
wherein the laser is a CW laser and weight ratio of the flaky metal effect pigment to the flaky pearlescent pigment in the pigment mixture contained in the printing ink is in a range of 0.095 to 2.00, preferably in a range of 0.10 to 1.00, more preferably in a range of 0.125 to 0.30, further preferably in a range of 0.15 to 0.25 and most preferably in a range of 0.15 to 0.20.

### EXAMPLES

### Comparative Example Series 1

Various pearlescent pigments (all from Eckart GmbH) were chosen and applied in a testing printing ink. The pearlescent pigments were used in pure form as suggested by WO 2019/154980 A1. Comp. Example 1a was not a pearlescent pigment as here only a transparent substrate (synthetic mica) was used.

The testing ink composition was as follows:
Methoxy methyl butanol (solvent): 53.2 wt. %
Disperbyk 111 (additive): 0.80 wt-%
Hydroxypropylcellulose (thickener, Klucel H): 6.0 wt. %
Mowital B2OH (PVB; binder): 30.0 wt. %
Pearlescent pigment: 10.0 wt. %

The inks containing the pearlescent pigments were applicated by a draw-down using a 60 μm doctor knife on a glass plate having a thickness of about 2 mm. A marking laser (sic-marking XBox) having a maximum power of 20 W was used at a frequency of 20 kHz and a wavelength of 1064 nm from the backside of the glass plate hitting the ink draw-down. The probe was immobilized and the laser beam scanned the probe with a velocity of 4 m/s.

Near to the glass plate a plastic substrate was located at a distance of about 2 mm with 100 individual stripes. Each stripe was subject to a potential printing process while the laser power was gradually increased from 1 to 100% of the power. The stripe pattern is visualized in FIG. 2.

The maximal pulse energy corresponding to 100% of the laser power was 1.00 mJ. The laser frequency used was 25,000 1/s. From this the pulse energy could be calculated using the simple formula:

$$E [ m J ] = Power [ mW ] \text{/frequency} [ 1 / s ] \qquad ( IV )$$

In table 1 the pearlescent pigments with their size range and their principle layer compositions are depicted with the laser threshold energies where an acceptable transfer of pearlescent pigment to the plastic substrate was observed.

TABLE 1
Pearlescent pigments used as Comp. Examples and laser power
and pulse energies necessary for pigment transfer.

| | | | | | Laser power | |
|---|---|---|---|---|---|---|
| | | | | | in % and | |
| | Name of | | Size | | calc. pulse | |
| | Pearlescent | Interference | range | Pigment | energy in mJ | |
| Sample | pigment | color | [μm] | structure | % | [mJ] |
| Comp. | Synafil ® S115 | colorless | 1-15 | synth. mica | 96 | 0.96 |
| Ex. 1a | | | | only | | |
| Comp. | Symic ® A001 | Silver | 1-15 | synth. mica/ | 95 | 0.95 |
| Ex 1b | | | | TiO₂ | | |
| Comp. | Luxan ® B001 | silver | 5-45 | glass flake/ | 98 | 0.98 |
| Ex 1c | | | | TiO₂ | | |
| Comp. | Luxan ® B241 | red | 5-45 | glass flake/ | 93 | 0.93 |
| Ex 1d | | | | TiO₂ | | |
| Comp. | Luxan ® B261 | blue | 5-45 | glass flake/ | 93 | 0.93 |
| Ex 1e | | | | TiO₂ | | |
| Comp. | Luxan ® B512 | champagne | 5-45 | glass flake/ | 39 | 0.39 |
| Ex 1f | | | | iron oxide | | |
| Comp. | Luxan ® B542 | fire red | 5-45 | glass flake/ | 33 | 0.33 |
| Ex 1g | | | | Fe₂O₃ | | |
| Comp. | Edelstein Ruby | red | 10-40 | synth mica/ | 26 | 0.26 |
| Ex 1h | | | | tin/iron | | |
| | | | | oxides/ | | |
| | | | | spacer layer/ | | |
| | | | | tin/iron | | |
| | | | | oxides | | |
| Comp. | Edelstein ® | orange | 10-40 | synth mica/ | 28 | 0.28 |
| Ex 1i | Topaz | | | tin/iron | | |
| | | | | oxides/ | | |
| | | | | spacer layer/ | | |
| | | | | tin/iron | | |
| | | | | oxides | | |
| Comp. | Syncrystal ® soft | black | 1-15 | synth. mica/ | 16 | 0.16 |
| Ex 1j | black | | | black iron | | |
| | | | | oxide | | |
| Coml. | Symic ® A502 | bronze | 1-15 | synth. mica/ | 27 | 0.27 |
| Ex 1k | | | | Fe₂O₃ | | |
| Comp. | Symic ® A522 | copper | 1-15 | synth. mica/ | 28 | 0.28 |
| Ex 1l | | | | Fe₂O₃ | | |
| Comp. | Symic ® C522 | bronze | 10-40 | synth. mica/ | 34 | 0.34 |
| Ex 1m | | | | Fe₂O₃ | | |
| Comp. | Symic ® C542 | fire red | 10-40 | synth. mica/ | 32 | 0.32 |
| Ex 1n | | | | Fe₂O₃ | | |
| Comp. | Symic ® opaque | silver | 5-25 | synth. mica/ | 31 | 0.31 |
| Ex 1o | B604 | | | tin oxide/ | | |
| | | | | titanium | | |
| | | | | oxide/iron | | |
| | | | | oxide | | |
| Comp. | Symic ® opaque | silver | 10-40 | synth. mica/ | 34 | 0.34 |
| Ex 1p | C604 | | | tin oxide/ | | |
| | | | | titanium | | |
| | | | | oxide/iron | | |
| | | | | oxide | | |

The pearlescent pigments of Comp. Examples 1b to 1e are transparent pigments and also laser transparent pigments, because TiO₂ is a non-absorbing metal oxide in the visible range and at the laser wavelength of 1064 nm and of course, the glass flake substrate is as well non-absorbing. These pearlescent pigments needed a very high laser power to be transferred. Without being bound to a certain theory it is assumed that these pigments cannot absorb enough energy from the laser beam as the colors here are purely interference colors without absorption of laser light. Therefore no energy can be transferred to the pearlescent pigments and the laser energy is too high for ensuring a save printing process without destroying the pearlescent pigments.

All other pearlescent pigments used were of an absorbing type as they contain red-colored Fe₂O₃. According to literature data hematite has an absorbing band starting in the visible range. In the IR region at 1064 nm the absorption decreases (absorption coefficient: 0.011; refractive index: 2.75). Although the absorption is not strong these pearlescent pigments need strikingly lower energies to be activated for a transfer during the printing process.

Not surprisingly the black pearlescent pigment of Comp. Example 1k needed the lowest power (16%) or pulse energy to be transferred.

The pearlescent pigments according to Comp. Example 1h and 1i are multilayer pigments wherein the low-refractive index middle layer is a so-called “spacer layer” which is composed of a majority of a hollow space and connectors. Such pearlescent pigments are described in EP 3034562 B1, EP 3034563 B1 and EP 3234024 B1.

A non-absorbing pearlescent pigment (Comp. Example 1c) and an absorbing pearlescent pigment (Comp. Example 1i) were chosen for further evaluations in order to decrease the laser energy for a successful printing process.

Example series 2: A series of printing inks were prepared with essentially constant amounts of the pearlescent pigment Luxan B001 (Comp. Example 1c) and varying amounts of a PVD metal effect pigment dispersion (Metalure® A-41008 MB, a 10% by weight dispersion of a PVD aluminum pigment from Eckart GmbH). Details regarding the components and their concentrations can be depicted from table 2.

The amount of binder dispersed in a solvent was held constant at 95 parts per weight.

These 95 parts per weight binder was composed of following components:
Methoxy methyl butanol (solvent): 90.85 parts per weight
Disperbyk 111 (additive): 0.84 parts per weight
Hydroxypropylcellulose (Klucel H): 0.13 parts per weight
Mowital B2OH (PVB; binder): 3.17 parts per weight

Example series 3: A series of printing inks were prepared with constant amounts of the pearlescent pigment Edelstein® Topaz Orange (Comp. Example 1i) and varying amounts of a PVD metal effect pigment dispersion (Metalure® A-41008 MB, a 10% by weight dispersion of a PVD aluminum pigment from Eckart GmbH). The same ink components as in Example series 2 was used. Details regarding the components and their concentrations can be depicted from table 2.

The ink samples containing the pearlescent pigments was applicated by a draw-down on a glass plate. A pulsed marking laser (sic-marking XBox) having a maximum power of 20 W was used with 20 KHz frequency from the backside of the glass plate hitting the ink draw- down. The probe was immobilized and the laser beam scanned the probe with a velocity of 4 m/s.

Near to the glass plate a plastic substrate was located in a distance of about 2 mm with 100 individual stripes. Each stripe was subject to potential printing process while the laser power was gradually increased from 1 to 100% of the power. The test stripe pattern is shown in FIG. 1. The maximal pulse energy corresponding to 100% of the laser power was 1 mJ.

Each printing pattern was evaluated with regard to the energy regime used of the laser with respect to the following criteria: a) the minimum energy (threshold level) were beginning of transfer of pearlescent pigment to substrate is noticed, b) evolution of a good pearlescent effect and c) the overall optical appearance: this denotes to the overall optical effect as at too high laser energies a destroying of the flaky metal pigments was observed. Finally an overall regime of the laser energy was evaluated were printing was possible and an attractive optical effect with pearlescent appearance was observed. The results of these evaluations are depicted in table 2. The laser is characterized by the power level in % and below this value as the calculated pulse energy in mJ.

TABLE 2a
Composition details or printing inks used in Example 2 and Example 3 series

| | Printing Ink | | | | | |
|---|---|---|---|---|---|---|
| | | | | Concentrations of effect | | |
| | Components of effect | | | pigments calculated from | | |
| | pigments and binder in the | | | printing ink composition | | |
| | printing ink in parts by weight | | | Concentrat-on | | Weight Ratio |
| | Amount | Amount | | pearlescent | Concentration | PVD-aluminum |
| | pearlescent | PVD-pigment | Amount | pigment | PVD-pigment | to pearlescent |
| Sample | pigment | dispersion | binder | (wt. %) | (wt. %) | pigment |
| Ex. 2a | 5.0 | 10.0 | 95.0 | 4.55% | 0.91% | 0.20 |
| Ex. 2b | 5.0 | 8.0 | 95.0 | 4.63% | 0.74% | 0.16 |
| Ex. 2c | 5.0 | 6.0 | 95.0 | 4.72% | 0.57% | 0.12 |
| Ex. 2d | 5.0 | 4.0 | 95.0 | 4.81% | 0.38% | 0.08 |
| Ex. 2e | 5.0 | 2.0 | 95.0 | 4.90% | 0.20% | 0.04 |
| Ex. 2f | 5.0 | 1.0 | 95.0 | 4.95% | 0.10% | 0.02 |
| Ex. 3a | 5.0 | 10.0 | 95.0 | 4.55% | 0.91% | 0.200 |
| Ex. 3b | 5.0 | 8.0 | 95.0 | 4.63% | 0.74% | 0.160 |
| Ex. 3c | 5.0 | 6.0 | 95.0 | 4.72% | 0.57% | 0.121 |
| Ex. 3d | 5.0 | 4.0 | 95.0 | 4.81% | 0.38% | 0.080 |
| Ex. 3e | 5.0 | 2.0 | 95.0 | 4.90% | 0.20% | 0.040 |
| Ex. 3f | 5.0 | 1.0 | 95.0 | 4.95% | 0.10% | 0.020 |
| Ex. 3g | 5.0 | 0.8 | 95.0 | 4.96% | 0.08% | 0.016 |
| Ex. 3h | 5.0 | 0.6 | 95.0 | 4.97% | 0.06% | 0.012 |
| Ex. 3i | 5.0 | 0.4 | 95.0 | 4.98% | 0.04% | 0.008 |
| Ex. 3j | 5.0 | 0.2 | 95.0 | 4.99% | 0.02% | 0.004 |

TABLE 2b
Results for useable laser energies of samples of table 2a

| | Evaluation of laser power in % or | | | | |
|---|---|---|---|---|---|
| | calculated pulse energy in mJ; pulsed laser | | | | |
| | | Good pearlescent | | Good overall | |
| | Threshhold level of | Effect | | optical appearance | |
| Sample | pigment transfer | Min | Max | Min | Max |
| Ex. 2a | 12% | 13% | 34% | 14% | 15% |
| | 0.12 | 0.13 | 0.34 | 0.14 | 0.15 |
| Ex. 2b | 12% | 13% | 35% | 14% | 17% |
| | 0.12 | 0.13 | 0.35 | 0.14 | 0.17 |
| Ex. 2c | 12% | 13% | 35% | 14% | 20% |
| | 0.12 | 0.13 | 0.35 | 0.14 | 0.20 |
| Ex. 2d | 12% | 20% | 24% | 21% | 23% |
| | 0.12 | 0.20 | 0.24 | 0.21 | 0.23 |
| Ex. 2e | 12% | 16% | 60% | 16% | 60% |
| | 0.12 | 0.16 | 0.60 | 0.16 | 0.6 |
| Ex. 2f | 13% | 20% | 75% | 24% | 55% |
| | 0.13 | 0.20 | 0.75 | 0.24 | 0.55 |
| Ex. 3a | 12% | 50% | 72% | 52% | 70% |
| | 0.12 | 0.50 | 0.72 | 0.52 | 0.70 |
| Ex. 3b | 12% | 45% | 80% | 50% | 73% |
| | 0.12 | 0.45 | 0.80 | 0.50 | 0.73 |
| Ex. 3c | 12% | 20% | 49% | 45% | 50% |
| | 0.12 | 0.20 | 0.49 | 0.45 | 0.50 |
| Ex. 3d | 13% | 23% | 48% | 28% | 80% |
| | 0.13 | 0.23 | 0.48 | 0.28 | 0.80 |
| Ex. 3e | 21% | 27% | 74% | 29% | 61% |
| | 0.21 | 0.27 | 0.74 | 0.29 | 0.61 |
| Ex. 3f | 24% | 28% | 70% | 29% | 47% |
| | 0.24 | 0.28 | 0.70 | 0.29 | 0.47 |
| Ex. 3g | 25% | 29% | 72% | 30% | 57% |
| | 0.25 | 0.29 | 0.72 | 0.30 | 0.57 |
| Ex. 3h | 25% | 29% | 69% | 30% | 66% |
| | 0.25 | 0.29 | 0.69 | 0.30 | 0.66 |
| Ex. 3i | 25% | 29% | 70% | 29% | 62% |
| | 0.25 | 0.29 | 0.70 | 0.29 | 0.62 |
| Ex. 3j | 26% | 29% | 64% | 30% | 59% |
| | 0.26 | 0.29 | 0.64 | 0.30 | 0.59 |

Some of the samples of Example 2 and Example 3 series were also printed in another configuration using a CW-laser.

### LIFT Printing Examples with CW Laser

Samples of Examples 2 and Example 3 series were used in LIFT printing process. The LIFT apparatus used was principally described in WO 2019/175056 A1 and especially in FIG. 1 therein. In a LIFT printing apparatus the inking unit is provided with the respective samples of inks as listed in table 3. The inking unit was adjusted so that the ink ribbon was continuously coated with a homogeneous ink layer and a wet film thickness of approx. 25 μm. The ink is renewed after each revolution of the ribbon to ensure homogeneous printing conditions.

The laser is then adjusted so that the focus collects in the ink exactly through the ribbon. In the ink, the laser triggers a thermal light effect that places the ink on an opposing substrate without contact. The distance substrate to printhead is kept constant.

The laser used is a fiber laser from the company IPG with a wavelength of 1080 nm. The laser itself is a CW laser with a maximum power of 300 W. The working or printing focus has a diameter of approx. 50 μm. The laser is switched classically via an accusto optical modulator with 0.2 mm aperture.

The laser energy was increased until a stable pigment transfer was observed. The respective laser energy was noted. The laser energy per dot was calculated therefrom considering the focus diameter and the scan speed (about 400 m/s). A classic test pattern for printing which involved a wide variety of patterns was used for evaluation. The quality of the printed test pattern was evaluated by visual inspection of the printed patterns combined with a qualitative noting system. All samples denoted as “bad” were not usable for printing (Comparative Examples).

Additionally four Comparative Examples involving printing inks with pure pearlescent pigments (without any flaky metal pigment) according to WO 2019/154980 A1 were printed in this configuration. These pearlescent pigments involve an SnO₂ doted TiO₂ layer as high refractive index material. The details and the results are depicted in table 3.

Comparative Example 4a: Spectraval™ White (Merck KGA)

Comparative Example 4b: Spectraval™ Green (Merck KGA)

Comparative Example 4c: Spectraval™ Red (Merck KGA)

Comparative Example 4d: Spectraval™ Blue (Merck KGA)

TABLE 3
Results of printing experiments with CW-laser in a LIFT process:

| | | | Visual |
|---|---|---|---|
| | | | appearance |
| | Power Laser | Energy Laser | printed test |
| Sample | [W] | [μJ] | pattern |
| Ex. 2b | 100 | 12.5 | good |
| Ex. 2c | 110 | 13.8 | even good |
| Ex. 2d | 115 | 14.4 | average |
| Ex. 2e | 120 | 15 | even average |
| Comp. Ex. 2f | 140 | 17.5 | bad |
| Ex. 3a | 100 | 12.5 | good |
| Ex. 3b | 100 | 12.5 | good |
| Ex. 3c | 120 | 15 | average |
| Comp. Ex. 3d | 145 | 18.1 | bad |

| | |
|---|---|
| Comp. Ex. 3e-j | No pigment transfer, |
| | no printing possible |
| Comp. Ex. 4a | No pigment transfer, |
| | no printing possible |
| Comp. Ex. 4b | No pigment transfer, |
| | no printing possible |
| Comp. Ex. 4c | No pigment transfer, |
| | no printing possible |
| Comp. Ex. 4d | No pigment transfer, |
| | no printing possible |

### Experimental Results

For the non-absorbing pearlescent pigment of Comp. Example 1c surprisingly strikingly lower pulse energies of laser power of pigment transfer could be observed even for very low concentrations of metal effect pigment (Examples 2a to 2f in tables 2a,b). For all these examples a region of laser energies was found for good printing results with respect to the evolution of a pearlescent effect and an uniformly printed film. Interestingly the examples with higher metal pigment contents only have a rather low regime of the laser energies where a very good pearlescent effect were obtained and also the overall optical appearance was good. When using too low laser energies the transfer of the effect pigments was not accomplished in a satisfying manner. When using too high laser energies the optical appearance was disturbed by increasing perturbation of the pigments, especially the metal pigments. In between these extremities pigment transfer and printing was possible in a satisfying manner.

Especially Examples 2e and 2f showed very broad ranges of laser energy yielding good overall optical appearance.

For the absorbing pearlescent pigment of Comp. Example 1i the energy of pearlescent pigment transfer was also lowered form 28% to 12% or 13% at higher metal pigment concentrations. At these concentrations (Examples 3a-3d) a comparable transfer energy was observed as in the case of the non-absorbing pearlescent pigment indicating that the transfer is mainly triggered by energy absorption via the metal effect pigment. Interestingly the transfer energy was increased for Examples 3e and 3f when compared to Examples 2e and 2f.

The laser energy regimes of obtaining overall good optical appearance were for Examples 3a-3f broader than in case of the corresponding examples of the Example 2 series. It is assumed that in case of the transparent pearlescent pigment the effect of the metal effect pigment is strongly enhanced in that the laser energy is not filtered by the pearlescent pigment. Therefore, for “high” metal effect pigment concentrations the negative impact of too high laser energies is seen earlier.

For the Examples 3g-3j the energy for pearlescent pigment transfer slowly increases with decreasing metal effect pigment content but stayed still below 28% observed for the pure pearlescent pigment (Comp. Example 1i). The laser energy regimes always are rather broad ensuring a wider range of applicable laser energies.

Regarding the printing experiments done with the CW laser with the LIFT printing method (table 3) the inventive Examples 2b-e could be easily printed at very low laser energies and yielding “good” to “even average” printing results Comp. Example 2f could be transferred but the printing results were not satisfying as an inhomogeneous printing picture was obtained. Likewise the Examples 3a-d could be well transferred and printed using increasing laser energy with decreasing amount of the PVD aluminum flakes. Comp. Example 3d did, however, not yield a satisfying printing result and was therefore denoted as a comparative example.

Furthermore, the inks of Comp. Examples 3e-j could not be transferred at all and thus not be printed. Here, the amount of the absorbing metal pigments seemed to be too low. No pigment transfer at all was observed for the pearlescent pigments without the addition of flaky metal pigments (Comp. Examples 4a-d). It appears that the energy in the CW mode is too low to transfer pure pearlescent pigments here. In addition, no pigment transfer was observed when the pure pearlescent pigments of the example 2 series (Luxan B001) and the example 3 series (Edelstein® Topaz Orange) were used in the LIFT printing with the CW laser (not shown in table 3).

1. A method for radiation induced printing comprising the following steps:
A) printing a printing ink comprising effect pigments on an ink carrier, which is optically transparent at a certain wavelength; followed by
B) irradiating the ink carrier by means of an energy-emitting apparatus emitting energy in the form of electromagnetic waves comprising the certain wavelength during a process period, wherein the printing ink absorbs energy of the electromagnetic waves and undergoes a change in volume and/or position causing a transfer of droplets of the printing ink from the ink carrier to an imprinting material,
wherein the printing ink comprises an effect pigment mixture containing
a) flaky pearlescent pigments and
b) flaky metal effect pigments.

2. The method for radiation induced printing according to claim 1,
wherein the energy-emitting apparatus is a laser.

3. The method for radiation induced printing process according to claim 1,
wherein the flaky metal effect pigment has an average thickness in a range of 15 to 50 nm.

4. The method for radiation induced printing according to claim 1,
wherein the flaky pearlescent pigment comprises a laser transparent substrate and at least one first metal oxide with a refractive index of >1.8, wherein the at least one first metal oxide is laser transparent.

5. The method for radiation induced printing according to claim 4, wherein the at least one laser transparent first metal oxide includes one or more of TiO₂, ZrO₂, SnO₂, ZnO and mixtures thereof.

6. The method for radiation induced printing according to claim 1,
wherein the flaky pearlescent pigment comprises a transparent substrate and at least one second metal oxide with a refractive index of >1.8, wherein the second metal oxide is laser absorbing.

7. The method for radiation induced printing according to claim 6,
wherein the at least one laser absorbing second metal oxide includes one or more of Fe₂O₃, Fe₃O₄, Fe(II) containing iron oxides, Cr₂O₃, SnO, Ti-suboxide, Fe and Ti mixed oxides, CuO, Ce-oxide and mixtures thereof.

8. The method for radiation induced printing according to claim 1,
wherein the energy-emitting apparatus is a pulsed laser, wherein the pulse energy of the electromagnetic waves is in a range of 0.10 to 0.90 mJ.

9. The method for radiation induced printing according to claim 8, wherein the laser is a pulsed laser and the concentration of flaky metal pigments in the printing ink is in a range of 0.01 to 1.50 wt. %, referred to the total printing ink.

10. The method for radiation induced printing according to claim 1,
wherein the energy-emitting apparatus is a CW laser and wherein the energy of the electromagnetic waves is in a range of 1 to 50 μJ.

11. The method for radiation induced printing according to claim 4,
wherein and the concentration of flaky metal pigments in the printing ink is in a range of 0.15 to 10.0 wt. %, referred to the total printing ink.

12. The method for radiation induced printing according to claim 6, wherein the laser is a CW laser and the concentration of flaky metal pigments in the printing ink is in a range of 0.45 to 10.0 wt. %, referred to the total printing ink.

13-15. (canceled)

16. The method for radiation induced printing according to claim 3, wherein the flaky metal effect pigment is a PVD aluminum effect pigment.
